(19) United States
(12) Patent Application Publication
(10) Pub. No.: US 2011/0038488 A1
(43) Pub. Date: Feb. 17, 2011

(54) WIRELESS MUSICAL INSTRUMENT NETWORK AND WIRELESS LINK MODULES

(76) Inventor: Scott Robert Humphreys, Greensboro, NC (US)

Correspondence Address: Scott R. Humphreys, 5702 Middlebury Place, Greensboro, NC, 27410, US

(21) Appl. No.: 12/851,200

(22) Filed: Aug. 5, 2010

Related U.S. Application Data
(60) Provisional application No. 61/232,937, filed on Aug. 11, 2009.

(51) Int. Cl. H04B 3/00

(52) U.S. Cl. 381/80

(57) ABSTRACT

A wireless musical instrument network (400, 500) may comprise one or more wireless link modules (100, 200, 300). In some embodiments a first wireless link module may be adapted to receive a first input audio signal and transmit a first wireless signal having a modulation component based on the first input audio signal. A second wireless link module may be adapted to receive the first wireless signal and a second input audio signal. The second wireless link module may be further adapted to demodulate the first wireless signal to provide a first received audio signal, and combine the first received audio signal and the second input audio signal to provide a combined audio signal. The second wireless link module may provide a second wireless signal having a modulation component based on the combined audio signal, whereby the combined audio signal and the second wireless signal contain information based on both the first input audio signal and the second input audio signal

### CROSS-REFERENCE TO RELATED APPLICATIONS

This application claims the benefit of provisional patent application Ser. No. 61/232,937, filed 2009 Aug. 11 by the present inventor.

### FIELD OF THE DISCLOSURE

The application relates to wireless transmission of signals containing audio information and, more particularly, to wireless transmission of signals containing audio information from two or more musical instruments or audio devices.

### BACKGROUND OF THE DISCLOSURE

Electronic audio equipment is used by professional and amateur musicians alike. Examples include electric or acoustic-electric guitars, electronic keyboards, microphones, and audio devices such as CD players, MP3 players, digital audio recorders and internet radio devices. Electric or acoustic-electric guitars contain transducers such as piezoelectric or magnetic coil pickups to translate the vibration of the guitar strings or the guitar body into a varying electrical signal (voltage and/or current) for further transmission via a dedicated cable to a dedicated amplifier. Alternatively, the signal may be coupled to electronic effect circuitry to simulate the characteristics of guitar amplifiers or to modify audio characteristics of the signal with frequency filtering or effects such as distortion or delay related effects such as flanging, phasing, chorusing or reverb, as is well known in the art. The modified signal may then be coupled to a dedicated amplifier or to a larger amplification system such as a ‘public address’ or PA system in an entertainment venue. Similarly, electronic keyboards, microphones and audio devices produce electrical signals that may be carried in dedicated cables to either dedicated amplifiers or PA systems. PA systems typically comprise a ‘mixing board’ receiving the many cables from the different amplifiers and instruments and having a large control panel to adjust the individual levels of each instruments signal, circuits to combine the signals from each instrument into a stereo signal pair (left and right channels), often with the ability to ‘place’ each signal at a different location in a stereo sound field, a power amplifier for each channel, and a set of speakers capable of producing a volume of sound appropriate to the room or venue.

For practice or informal situations where two or more musicians may gather to play their instruments together it is often impractical or undesirable to use the same amount and type of equipment employed in the professional venues as described above. One method of reducing the amount of equipment required is to use a small FM broadcast band radio transmitter dedicated to each instrument. The transmitter broadcasts a standard FM broadcast band radio signal that may be received on a home stereo or FM radio tuned to the same frequency as the transmitter. While convenient for an individual player, this method requires a unique amplifier for each player or device, or a dedicated mixer/PA system. First, the FM broadcast band radio signal produced by such dedicated transmitters contains information from only one audio source. Further it is not possible to combine different FM radio signals on a single FM radio channel frequency for reception by a single FM receiver due to capture effects inherent in FM demodulators, leading to distortion of one signal by another. In order to reproduce the audio signal from more than one instrument for the purposes of listening or recording, an additional FM radio receiver is required for each additional instrument or audio source. Thus these methods do not greatly reduce the amount and cost of equipment required to be transported and purchased.

Therefore a need exists for a low cost system that provides for combining signals from multiple instruments or audio devices, and that allows for cost and complexity to grow incrementally with the addition of each instrument or audio device.

### BRIEF DESCRIPTION OF THE DRAWINGS

For ease of understanding concepts described herein, the detailed description refers to the following drawings, in which:

FIG. 1 shows a wireless link module in accordance with some embodiments;

FIG. 2 shows a wireless link module in accordance with some embodiments comprising an FM receiver and an FM transmitter;

FIG. 3 shows a wireless link module in accordance with some additional embodiments;

FIG. 4 shows a wireless musical instrument network in accordance with some embodiments; and

FIG. 5 shows a wireless musical instrument network in accordance with some additional embodiments.

### DETAILED DESCRIPTION

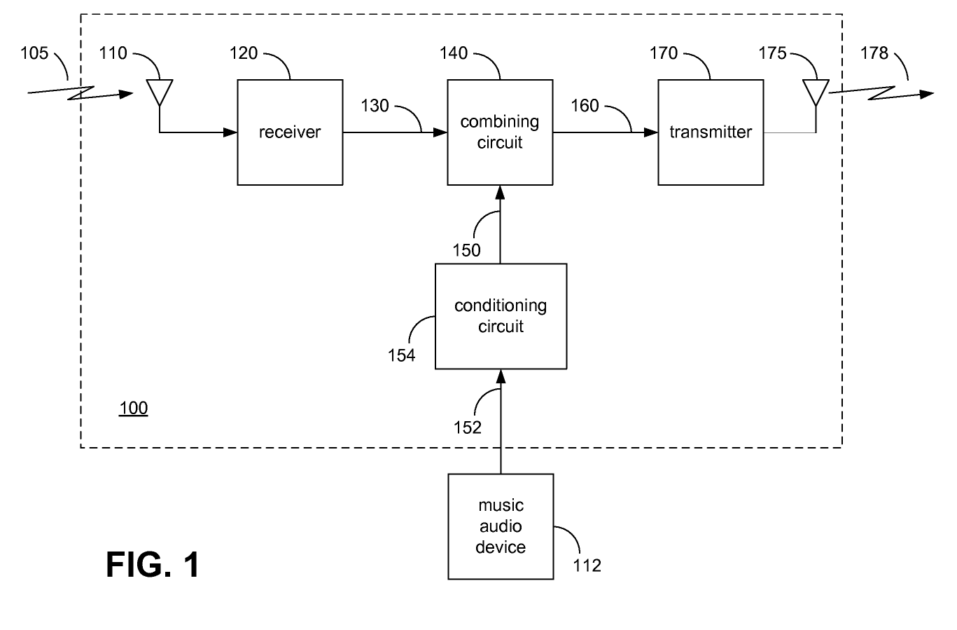

Some embodiments of a wireless link module are illustrated in FIG. 1. A wireless link module 100 may comprise a receive antenna 110, a receiver 120, a combining circuit 140, a conditioning circuit 154, a transmitter 170, and a transmit antenna 175. A music audio device 112 may be coupled to wireless link module 100. Here and throughout this specification the term music audio device refers to a musical instrument or electronic device capable of providing a signal containing music related audio information. The receive antenna 110 receives a first wireless signal 105 and provides it in electrical form to the receiver 120. The receiver 120 demodulates the first wireless signal 105 to provide a first received audio signal 130. The conditioning circuit 154 receives an input audio signal 152 from the music audio device 112 and provides a second audio signal 150 based on the input audio signal 152. The conditioning circuit 154 may buffer the input audio signal 152 or modify audio characteristics of the second audio signal 150 by applying one or more audio effects or modifications such as compression, distortion, reverb, flanging, phasing, chorusing or similar signal modifications in a conventional manner. The combining circuit 140 receives the first received audio signal 130 and the second audio signal 150 and combines them to provide a combined audio signal 160 based on both the first received audio signal 130 and the second audio signal 150. The transmitter 170 receives the combined audio signal 160 and generates a radio frequency signal at a predetermined transmit frequency. The transmitter 170 modulates the radio frequency signal based on the combined audio signal 160 to produce a second wireless signal 178 which is coupled to and broadcast by the transmit antenna 175. In this way the wireless link module 100 provides the second wireless signal 178 containing information based on both the first received audio signal 130 and the second audio signal 150. Though not illustrated in FIG. 1, the combined audio signal 160 may be coupled to an output of the wireless link module 100, for example to be coupled to an input of an audio playback or recording device.

Several additional aspects of the embodiments of FIG. 1 will be appreciated as follows. The wireless link module 100 may be small and integrated into the body an instrument or the case of an audio device. The wireless link module 100, whether within the body or case or external, may be coupled to the music audio device by a short cable so as to receive the input audio signal 152. The short cable may be directly attached by means of solder lugs or screw terminals at one or both ends, or the cable may include a mechanical connector at one or both ends mating to a connector in the corresponding device. Example connectors include quarter-inch (¼ in.) plugs and jacks as commonly used on guitar and instrument cables, eighth-inch (⅛ in.) plugs and jacks as commonly used on headphone and portable audio devices, and a variety of shielded or unshielded connector types used with or within electronic equipment. The input audio signal 152 may be coupled in electrical form to the input conditioning circuit 154. The input audio signal 152 may be produced by a transducer in or attached to the music audio device 112, in the body of an acoustic instrument, or by an electronic line amplifier having either a low or high impedance output, and either as a balanced or unbalanced signal pair as are well known in the art. In alternative embodiments a transducer could be integrated into the wireless link module 100 such that the input audio signal 152 is provided within the wireless link module 100 by the integrated transducer rather than being provided as an external signal at an input to the wireless link module 100.

The combining circuit 140 may comprise a circuit that generates the combined audio signal 160 as a weighted sum of the first received audio signal 130 and the second audio signal 150. The combining circuit 140 may further provide for adjustment of the relative amplitudes of the received audio signal 130 and the second audio signal 150 at a fixed predetermined ratio or to a ratio determined by a control value under the control of a user as are well known techniques in the art. The average or peak amplitude of the combined audio signal 160 may be adjusted to a set point determined by a control value under the control of a user or regulated by an automatic gain control circuit having a predetermined set point as is well known in the art. The predetermined transmit frequency may be set under the control of a user or by an automatic system providing for channel selection and coordination in some embodiments. User control may be effected via a control interface coupled to the wireless link module 100. An example of a predetermined method is to first normalize the amplitudes of the received audio signal 130 and the second audio signal 150 and then to combine them each with a weight of one-half. Other ratios may be appropriate in other situations. For example, if the received audio signal 130 comprises information from two music audio devices, a weighting of two-thirds for the received audio signal 130 and one-third for the second audio signal 150 may provide a more balanced sound in the combined audio signal 160.

In some embodiments the audio signals 130, 150 and 160 and the combining circuit 140 may utilize continuous time analog electrical signals. In this case the combining circuit may combine the signals with a conventional voltage mode circuit such as a summing operational amplifier topology, or with a current mode circuit such as a set of one or more amplifiers having current mode outputs with adjustable gain and output current where the currents are summed at a single node or set of nodes to produce the combined audio signal 160.

In some embodiments the audio signals 130, 150 and 160 and the combining circuit 140 may utilize discrete time (sampled) digital signal formats. In this case the combining circuit 140 may comprise a digital adder with unique weighting coefficients applied to the received audio signal 130 and the second audio signal 150 as is well known in the art.

It will be appreciated that the conditioning circuit 154 may enable use of the wireless link module 100 in applications where signal conditioning or audio effects may be desirable, such as with a voice microphone or an electric guitar. The conditioning circuit 154 may modify the audio characteristics under the control of a user who may fine tune one or more parameters of the audio. Alternately or in addition the conditioning circuit 154 may provide one or more predetermined settings, of which one or more may be selected by the user. The user control may be provided to the conditioning circuit 154 by a user interface coupled to the wireless link module 100 by control information provided on a separate physical or logical channel to the receiver 120 as discussed below.

Those of ordinary skill in the art will recognized that the conditioning circuit 154 or the combining circuit 140 may be implemented using analog or digital techniques. Analog techniques include well known voltage or current mode circuits based on transistors, transconductors or operational amplifiers and passive linear and non-linear components to create amplifiers or audio effect circuits; these may be discrete or integrated circuit based. Digital techniques include the use of analog-to-digital or digital-to-analog data converters where necessary to translate between analog and digital signal representations and the use of either dedicated or programmable digital signal processing blocks such as provided by digital circuits or digital signal processors (DSPs), and may be assembled from off the shelf components, implemented in programmable logic or gate array devices, implemented in custom digital or mixed-signal ICs or in an off-the-shelf DSP IC or mixed-signal IC as are well known in the art.

The receive antenna 110 and the transmit antenna 175 may be formed as a single antenna structure with separate coupling paths to the receiver 120 and the transmitter 170. The receive antenna 110 or the transmit antenna 175 may be internal or external to the wireless link module 100 and may comprise a short length of wire, a manufactured antenna component or a printed circuit antenna structure manufactured on a printed circuit board as is well known in the art.

The transmitter 170 and the receiver 120 may be configured to be compatible such that a wireless signal transmitted from one wireless link module 100 may be successfully received and demodulated by another similar wireless link module. Thus the frequency bands and modulation format of the second wireless signal 178 may be supported by the receiver 120. In this way the second wireless signal 178 may be utilized to link to another wireless link module 100 or similar wireless link modules described herein for some embodiments. The transmitter 170 and the receiver 120 may be configured to operate in an unlicensed radio band. Here and throughout this specification the term unlicensed band refers to a radio frequency band in which operation does not require a dedicated operator license. Examples include the Industrial, Scientific and Medical (ISM) bands or the “white space” TV bands, though the FCC and similar governing bodies are frequently modifying spectrum allocations to open up or restrict different bands so these are given as merely representative examples not intended to be limiting to the scope of the disclosure. In these bands a variety of modulation formats is allowed and may be appropriate including conventional digital modulation formats such as phase shift keying (PSK), frequency shift keying (FSK), amplitude shift keying (ASK), on-off keying (OOK), orthogonal frequency-division multiplexing (OFDM), or quadrature amplitude modulation (QAM), which may be implemented with one or more of a number of symbols and levels of deviation, with additional phase rotations per symbol period, and with or without pulse shaping. With all modulation formats, analog or digital, the resulting radio signal may have one or more modulation components based at least in part on the signal carrying the information to be transmitted. Such modulation components include an amplitude, frequency or phase of the radio signal and may include combinations of the instantaneous amplitude, frequency or phase, or changes in these components over time. In addition, operation in some unlicensed bands may require a form of spread spectrum modulation to reduce interference between devices sharing the spectrum in the vicinity of each other. Direct sequence and frequency hopping spread spectrum are common examples. One or more multiple access methods such as time division multiple access (TDMA), frequency division multiple access (FDMA) or code division multiple access (CDMA) may be useful for providing for transmission and reception of additional information such as control information in addition to the audio information. Such control information may comprise multiple control values for different functions and may be transmitted on a different logical channel. As is well known in the art, a logical channel may be defined by a particular message type transmitted on a physical channel that may be used for many types of messages. A physical channel may be defined by a time slot or channel frequency for TDMA or FDMA, respectively, or a code sequence in the case of CDMA. In the case of digital modulation formats and multiple access methods, the receiver 120 and the transmitter 170 may provide for reception and transmission of control information provided on either a physical or logical channel from another wireless link module or related device. Such control information could control the predetermined transmit frequency of the second wireless signal 178, the relative levels of the received audio signal 130 and the second audio signal 150 in the combined audio signal 160, parameters related to the conditioning circuit 154, or other parameters within the wireless link module 100. An advantage of digital modulation is that the audio information may be sent in message packets at a higher data rate than the signal bandwidth requires, allowing time for transmission of additional information such as control information in addition to the audio data in a TDMA format.

The transmitter 170 and the receiver 120 may be implemented in an integrated circuit (IC) such as an off-the-shelf standard product or a custom IC, or with a combination of ICs and/or discrete components as are well known in the art for various types of transmitters and receivers. The receiver 120 and the transmitter 170 may operate on different radio frequency channels wherein the frequency channels may be selected to be channels relatively free of interference from other devices. Channel selection may be under the control of a user via a control interface coupled to the wireless link module 100 or under the control of a master device via a physical or logical control channel as discussed above.

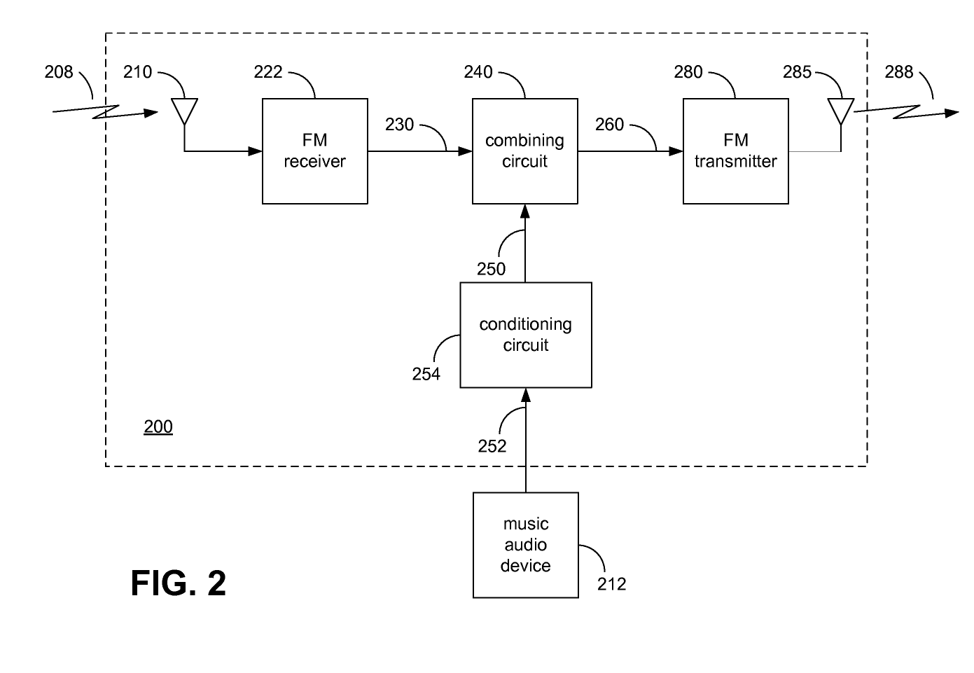

Some embodiments of a wireless link module comprising an FM receiver and an FM transmitter are shown in FIG. 2 wherein the reference numerals associated with similar components have received the same number as in FIG. 1 but incremented by the value of 100. Explanations and alternative embodiments described for the elements in FIG. 1 are intended to apply to said similar elements in FIG. 2. Elements that differ sufficiently to require explanation below are given reference numerals differing by other than the value 100. A wireless link module 200 may comprise a receive antenna 210, an FM receiver 222, a conditioning circuit 254, a combining circuit 240, a conditioning circuit 254, an FM transmitter 280, and a transmit antenna 285. Here and throughout this specification the FM broadcast band refers to the commercial FM radio band which in most countries occupies the frequency range of approximately 88 MHz to 108 MHz. The receive antenna 210 receives a first wireless signal 208 which may be an FM radio signal and provides it in electrical form to the FM receiver 222. The FM receiver 222 demodulates the first wireless signal 208 to provide a first received audio signal 230. The conditioning circuit 254 receives an input audio signal 252 from the music audio device 212 and provides a second audio signal 250 based on the input audio signal 252. The combining circuit 240 receives the first received audio signal 230 and the second audio signal 250 and combines them to provide a combined audio signal 260 based on both the first received audio signal 230 and the second audio signal 250. The FM transmitter 280 receives the combined audio signal 260 and generates a radio frequency signal at a predetermined transmit frequency. The FM transmitter 280 frequency modulates the radio frequency signal based on the combined audio signal 260 to produce a second wireless signal 288 which is coupled to and broadcast by the transmit antenna 285. In this way the wireless link module 200 provides the second wireless signal 288 containing audio information based on both the first received audio signal 230 and the second audio signal 250. The FM receiver 222 and the FM transmitter 280 may operate in a manner compatible with operation in the FM broadcast band and with standard FM broadcast band transmitters and receivers. The first wireless signal 208 and the second wireless signal 288 may be compatible with operation in the FM broadcast band and with standard FM broadcast band receivers.

The wireless link module 200 may enable a single FM band radio receiver to receive the second wireless signal 288 and recover the combined audio signal 260. It will be appreciated that in this case the second wireless signal 288 may be received by either an FM radio receiver coupled to an audio playback or recording system such as in a home stereo or portable radio for the purposes of playback or recording of the combined audio signal. Alternatively or in addition, the second wireless signal 288 may be received by another wireless link module similar to the wireless link module 200 or to one of the other embodiments described in this specification having an FM broadcast band receiver. In this way the second wireless signal 288 may be utilized to form a wireless link from the wireless link module 200 to another wireless link module.

The receive antenna 210 and the transmit antenna 285 may be formed as a single antenna structure with separate coupling paths to the receiver 222 and the transmitter 280. The FM broadcast band receiver 222 and the FM broadcast band transmitter 280 may be implemented in an integrated circuit (IC) such as an off-the-shelf standard product or a custom IC, or with a combination of ICs and/or discrete components as are well known in the art for FM transmitters and receivers. The FM broadcast band receiver 222 and the FM broadcast band transmitter 280 may operate on different radio frequency channels wherein the frequency channels may be selected to be channels relatively free of interference from other devices or broadcasters. Channel selection may be under the control of a user via a control interface coupled to the wireless link module 200.

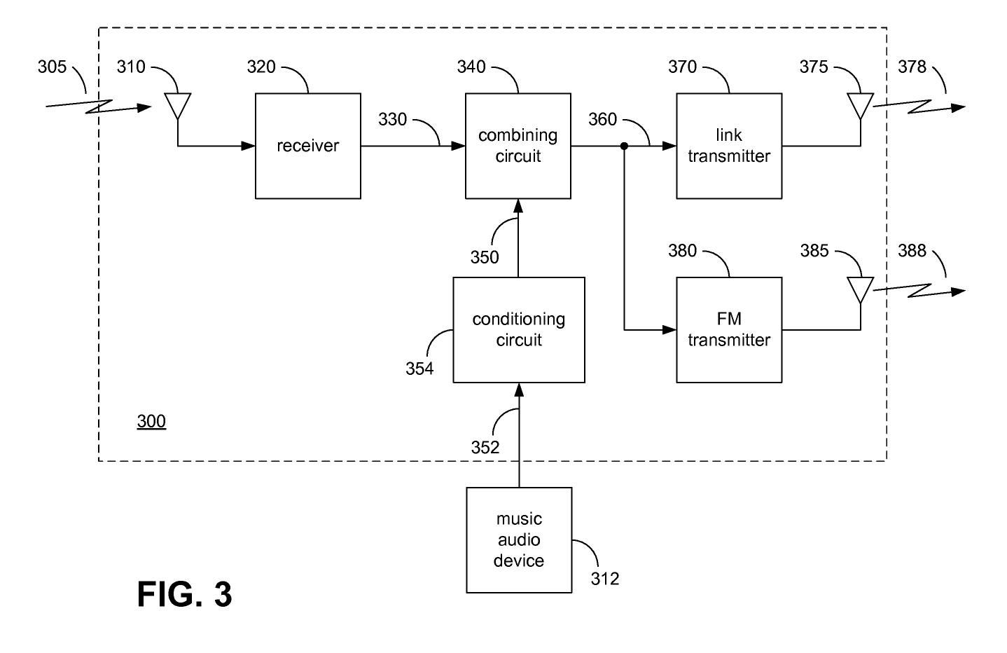

Some further additional embodiments of a wireless link module are illustrated in FIG. 3 wherein the reference characters associated with similar elements have received the same number as in FIG. 1 or FIG. 2 but incremented by the value of 200 or 100, respectively. Explanations and alternative embodiments described for the elements in FIG. 1 and FIG. 2 are intended to apply to said similar elements in FIG. 3. A wireless link module 300 may comprise a receive antenna 310, a receiver 320, a combining circuit 340, a conditioning circuit 354, a link transmitter 370, a link transmit antenna 375, an FM transmitter 380 and an FM antenna 385. The receive antenna 310 receives a first wireless signal 305 and provides it in electrical form to the receiver 320. The receiver 320 demodulates the first wireless signal 305 to provide a first received audio signal 330. The conditioning circuit 354 receives an input audio signal 352 from the music audio device 312 and provides a second audio signal 350 based on the input audio signal 352. The combining circuit 340 receives the first received audio signal 330 and the second audio signal 350 and combines them to provide a combined audio signal 360. The link transmitter 370 receives the combined audio signal 360 and generates a radio frequency signal at a predetermined link transmit frequency. The link transmitter 370 modulates the radio frequency signal with the combined audio signal 360 to produce a second wireless signal 378 coupled to and broadcast by the link transmit antenna 375. The FM band transmitter 380 receives the combined audio signal 360 and generates a second radio frequency signal at a predetermined transmit frequency. The FM band transmitter 380 frequency modulates the second radio frequency signal with the combined audio signal 380 to produce an FM radio signal 388 which is coupled to and broadcast by the FM antenna 385. In this way the wireless link module 300 provides the FM radio signal 388 and the second wireless signal 378 such that they contain audio information based on both the first received audio signal 330 and the second audio signal 350, which is based on the input audio signal 352.

In addition to alternative embodiments comprising combined receive and transmit antenna structures outlined above, the link transmit antenna 375 and the transmit antenna 385 may be formed as a single antenna structure with separate coupling paths to the link transmitter 370 and the FM transmitter 380.

It will be appreciated that, while not required for operation, the wireless link module 300 may be used with only one of either the link transmitter 370 or an FM band transmitter 380 enabled to reduce power consumption. The wireless link module 300 is a versatile device that may be used as a first, last or an intermediate node in a wireless musical instrument network similar to one or more of the embodiments described in this specification.

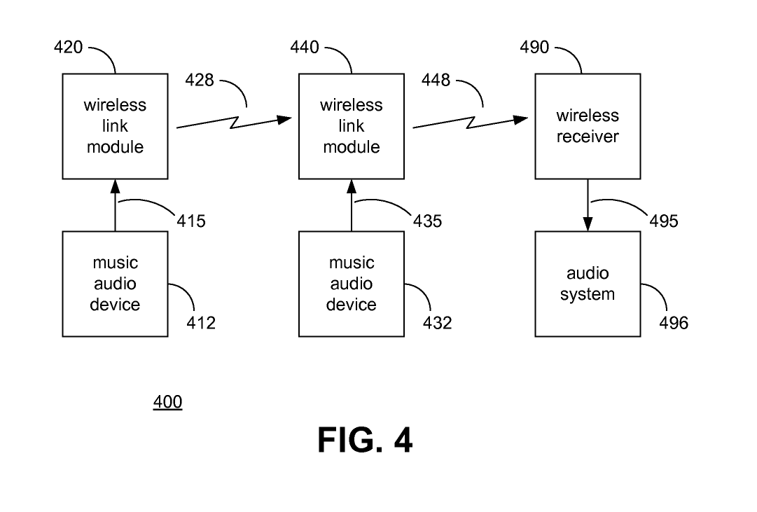

Some embodiments of a wireless musical instrument network are illustrated in FIG. 4. The wireless network 400 may comprise a first instrument or audio device 412, a first wireless link module 420, a second instrument or audio device 432, a second wireless link module 440, a wireless receiver 490, and an audio system 496. The first instrument or audio device 412 provides a first input audio signal 415 to the first wireless link module 420. The first wireless link module 420 transmits a first wireless signal 428 based on the first audio signal. The second wireless link module 440 receives the first wireless link signal 428 and demodulates the first wireless link signal 428 to provide a first received audio signal representative of the first audio signal 415. The second instrument or audio device 432 provides a second input audio signal 435 to the second wireless link module 440. The second wireless link module 440 produces a combined audio signal based on the first received audio signal and the second input audio signal 435. The second wireless link module 440 transmits a second wireless signal 448 based on the combined audio signal. The wireless receiver 490 receives and demodulates the second wireless signal 448 to provide a received combined audio signal 495. The audio system 496 receives the received combined audio signal 495 such that it can be played back or recorded in an ordinary manner. The audio system 496 may comprise audio electronic and sound reinforcement components such as an audio amplifier and speakers or headphones or an audio recording system. In the wireless network 400 the wireless link modules 420 and 440 may be similar to one or more of wireless link modules 100, 200, or 300.

In some embodiments of the wireless network 400 the wireless signals 428 and 448 may comprise FM radio signals, wireless link modules 420 and 440 may comprise FM transmitters, and the wireless link module 440 and the wireless receiver 490 may comprise FM receivers. In some other embodiments of the wireless network 400 the wireless signals 428 and 448 may comprise unlicensed band radio signals, wireless link modules 420 and 440 may comprise unlicensed band transmitters, and the wireless link module 440 and the wireless receiver 490 may comprise unlicensed band receivers. It will be appreciated that not all wireless signals need to be of the same type or operate in the same band; various combinations are possible. For example, a combination that may afford flexibility and some improved immunity to interference are embodiments in which the wireless signal 428 comprises an unlicensed band link signal and wireless signal 468 comprises an FM radio signal. The first wireless signal 428 and the second wireless signal 448 may have different channel or carrier frequencies selected to be channels relatively free of interference from other devices. Channel selection may be provided directly by one or more users via control interfaces associated with each wireless link module 420 and 440. In some wireless networks channel selection may be performed autonomously by microcontrollers within the wireless link modules 420 and 440 as is known for self-organizing networks. Alternately, channel selection may be under the remote control of one or more users or under the control of an autonomous master device via a physical or logical control channel.

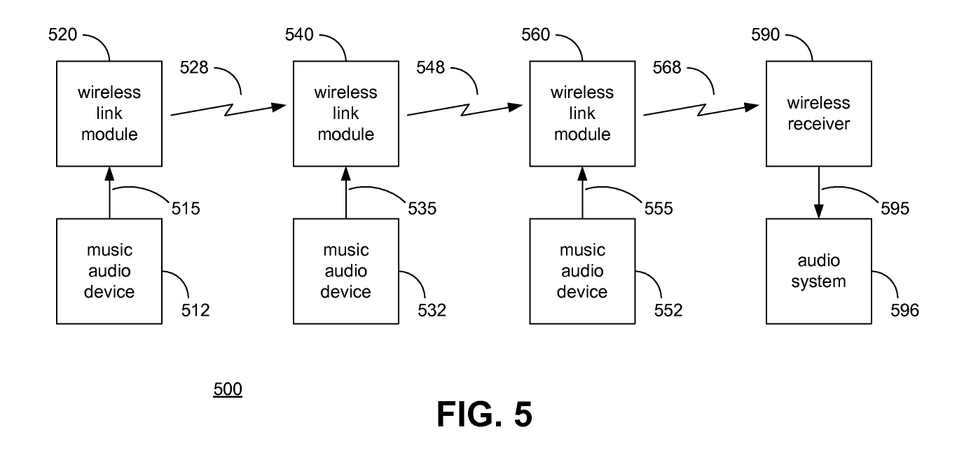

Some additional embodiments of a wireless musical instrument network are illustrated in FIG. 5 which illustrates how a larger network may be formed. It will be apparent that the concepts illustrated may be extended to networks comprising three or more wireless link modules 100, 200, or 300. The wireless network 500 may comprise a first instrument or audio device 512, a first wireless link module 520, a second instrument or audio device 532, a second wireless link module 540, a third instrument or audio device 552, a third wireless link module 560, a wireless receiver 590, and an audio system 596. The first instrument or audio device 512 provides a first input audio signal 515 to the first wireless link module 520. The first wireless link module 520 transmits a first wireless signal 528 based on the first audio signal. The second wireless link module 540 receives and demodulates the first wireless link signal 528 to provide a first received audio signal representative of the first audio signal 515. The second instrument or audio device 532 provides a second input audio signal 535 to the second wireless link module 540. The second wireless link module 540 provides a first combined audio signal based on the first received audio signal and the second input audio signal 535. The second wireless link module 540 transmits a second wireless signal 548 based on the first combined audio signal. The third wireless link module 560 receives and demodulates the second wireless link signal 548 to provide a second received audio signal representative of the first combined audio signal. The third instrument or audio device 552 provides a third input audio signal 555 to the second wireless link module 560. The third wireless link module 560 produces a second combined audio signal based on the second received audio signal and the third input audio signal 555. The third wireless link module 560 transmits a third wireless signal 568 based on the second combined audio signal. The wireless receiver 590 receives and demodulates the third wireless signal 568 to provide a received combined audio signal 595. The audio system 596 receives the received combined audio signal 595 such that it can be played back or recorded in an ordinary manner. The audio system 596 may comprise audio electronic and sound reinforcement components such as an audio amplifier and speakers or headphones or and audio recording system. In the wireless network 500 the wireless link modules 520, 540, and 560 may be similar to one or more of wireless link modules 100, 200, or 300. It is apparent that the wireless network 500 may be extended in a similar manner to a larger number of devices, thereby allowing a plurality of audio signals to be mixed in a convenient manner, wherein each wireless link module 520, 540, or 560 is a low cost device that may be owned by different users.

In some embodiments of the wireless network 500 the wireless signals 528, 548, and 568 may comprise FM radio signals, the wireless link modules 520, 540 and 560 may comprise FM transmitters, and the wireless link modules 540 and 560 and the wireless receiver 590 may comprise FM receivers. In some embodiments of the wireless network 500 the wireless signals 528, 548, and 568 may comprise unlicensed band radio signals, the wireless link modules 520, 540 and 560 may comprise unlicensed band transmitters, and the wireless link modules 540 and 560 and the wireless receiver 590 may comprise unlicensed band receivers. It will be appreciated that not all wireless signals need to be of the same type or operate in the same band; various combinations are possible. For example, a combination that may afford flexibility and some improved immunity to interference are embodiments in which the wireless signals 528 and 548 comprise unlicensed band link signals and wireless signal 568 comprises an FM radio signal. The first wireless signal 528, the second wireless signal 548 and the third wireless signal 558 may have different channel or carrier frequencies selected to be channels relatively free of interference from other devices. Channel selection may be provided directly by one or more users via control interfaces associated with each wireless link module 520, 540, and 560. In some wireless networks channel selection may be performed autonomously by microcontrollers within the wireless link modules 520, 540, and 560 as is known for self-organizing networks. Alternately, channel selection may be under the remote control of one or more users or under the control of an autonomous master device via a physical or logical control channel.

In some additional embodiments the wireless receiver 590 may comprise a wireless link module 100, 200 or 300 wherein the combined audio signal 160, 260 or 360 is provided as an output to the audio device. In this case a wireless link module 100, 200 or 300 may act as a final node in a network of wireless link modules operating in one or more unlicensed bands. Further in this case, the wireless link module 100, 200 or 300 of the wireless receiver 590 may receive an audio signal as input audio signal 152, 252 or 352 from an audio device such as an MP3 player, CD player, internet radio or other audio source devices to combine with the received audio signal 130, 230 or 330. In this way a wireless link module 100, 200 or 300 may provide a convenient method for one or more musicians to ‘play along’ with a recording of a song, taking advantage of the audio combining provided by a wireless link module to hear or record both their instrument(s) and the audio source material simultaneously through a single audio playback or recording system.

In some embodiments the wireless link modules 100, 200 or 300 may provide for receiving and providing control information from a user at one wireless link module 100, 200 or 300 to another wireless link module 100, 200 or 300. The control information provide one or more control values used to determine operating parameters of the wireless link module 100, 200 or 300 such as the operating frequency of a receiver or transmitter, relative amplitudes of the audio signals at the combining circuit 140, 240, or 340, and parameters determining the operation of the conditioning circuit 154, 254, or 354. The control information may be used to modify an operating parameter of a music audio device coupled to the wireless link module 100, 200 or 300, such as to control playback or recording functions such as start, stop, repeat, or song/track selection as well as parameters that affect audio characteristics of the reproduced or recorded audio signal. Coupling of the control information may be achieved through a wired connection of conventional design.

In some embodiments of the wireless network 400 and the wireless network 500 and related embodiments the wireless signals may comprise digitally modulated signals and the wireless link modules 100, 300, 420, 440, 520, 540, 520, 540, 560 and the wireless receivers 490 and 590 and related embodiments may comprise receivers and transmitters configured to operate with digital modulation formats or access methods as described above. In addition one or more multiple access methods may provide a physical or logical control channel to allow transmission of control information from one or more devices to one or more devices in addition to the audio information. The wireless network may provide for a physical control channel common to all wireless link modules in the network such as a specific time slot in a TDMA method or a specific channel frequency in an FDMA network.

Those skilled in the art will recognize that additional audio channels, such as for stereo or multichannel audio, and control channels may be provided up to the capacity and signal quality limits of the network environment. In the case of stereo or multichannel audio those skilled in the art will recognize that the related circuit elements and components of the wireless link modules 100, 200 and 300 will further comprise two or more signal paths, one for each audio channel, and may comprise additional circuits and control values to provide for adjustment of the placement of an audio signal in the stereo or multichannel sound field of the combined audio signal 160, 260 and 360.

### CONCLUSION

It will be appreciated that the wireless musical instrument network and wireless link modules provide a low cost system that provides for combining signals from multiple instruments or audio devices in a distributed manner throughout the network, allowing cost and complexity to grow incrementally with the addition of each instrument or audio device. Further the wireless musical instrument network and wireless link modules provide for control information to be sent from one device to another.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Those skilled in the art will recognize that a wide variety of modifications, alterations, and combinations can be made with respect to the above described embodiments without departing from the spirit and scope of the invention defined by the claims, and that such modifications, alterations, and combinations are to be viewed as being within the scope of the inventive concept. Thus, the specification and figures are to be regarded in an illustrative rather than a restrictive sense, and all such modifications are intended to be included within the scope of present invention defined by the claims. The benefits, advantages, solutions to problems, and any element(s) that may cause any benefit, advantage, or solution to occur or become more pronounced are not to be construed as a critical, required, or essential features or elements of any or all the claims. The invention is defined solely by any claims issuing from this application and all equivalents of those issued claims.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A wireless link module coupled to a music audio device, the wireless link module comprising:
a receiver adapted to
receive a first wireless signal, and
demodulate the first wireless signal to provide a first received audio signal based on a modulation component of the first wireless signal;
a conditioning circuit adapted to
receive an input audio signal from the music audio device, and
provide a second audio signal based on the input audio signal;
a combining circuit adapted to
receive the first received audio signal,
receive the second audio signal, and
provide a combined audio signal based on the first received audio signal and the second audio signal; and
a transmitter adapted to
receive the combined audio signal, and
provide a second wireless signal having a modulation component based on the combined audio signal;
whereby the combined audio signal and the second wireless signal contain information based on both the first received audio signal and the input audio signal.

2. The wireless link module of claim 1 wherein:
the receiver comprises an FM receiver further adapted to
provide the first received audio signal based on frequency demodulation of the first wireless signal; and
the transmitter comprises an FM transmitter further adapted to
generate a frequency-modulated radio frequency signal having a frequency modulation component based on the combined audio signal, and
provide the second wireless signal based on the frequency-modulated radio frequency signal and having a carrier frequency and a modulation format compatible with FM broadcast band radio receivers.

3. The wireless link module of claim 2 wherein the combining circuit is further adapted to adjust the relative amplitudes of the first received audio signal and the second audio signal present in the combined audio signal in response to a control value.

4. The wireless link module of claim 2 wherein the conditioning circuit is further adapted to modify an audio characteristic of the second audio signal.

5. The wireless link module of claim 1 wherein the transmitter comprises a link transmitter further adapted to
generate a modulated radio frequency signal having a modulation component based on the combined audio signal, and
provide the second wireless signal based on the modulated radio frequency signal and having a carrier frequency and a modulation format compatible with operation in an unlicensed radio band.

6. The wireless link module of claim 5 wherein the combining circuit is further adapted to adjust the relative amplitudes of the first received audio signal and the second audio signal present in the combined audio signal in response to a control value.

7. The wireless link module of claim 5 wherein the conditioning circuit is further adapted to modify an audio characteristic of the second audio signal.

8. The wireless link module of claim 5 further comprising:
an FM transmitter adapted to
receive the combined audio signal,
generate a frequency-modulated radio frequency signal having a frequency modulation component based on the combined audio signal, and
provide an FM radio signal based on the frequency-modulated radio frequency signal and having a carrier frequency and a modulation format compatible with FM broadcast band radio receivers;
whereby the FM radio signal contains information based on both the first received audio signal and the input audio signal.

9. The wireless link module of claim 8 wherein the conditioning circuit is further adapted to modify an audio characteristic of the second audio signal.

10. The wireless link module of claim 1 further comprising:
a user interface adapted to receive a control value from a user;
wherein the transmitter is further adapted to transmit a wireless control signal having a modulation component based on the control value.

11. The wireless link module of claim 1 wherein the receiver is further adapted to receive a wireless control signal and demodulate the wireless control signal to provide a received control value based on a modulation component of the wireless control signal.

12. A wireless network comprising:
a first wireless link module coupled to a first music audio device and adapted to
receive a first input audio signal from the first music audio device, and
provide a first wireless signal having a modulation component based on the first input audio signal; and
a second wireless link module coupled to a second music audio device and adapted to
receive the first wireless signal,
demodulate the first wireless signal to provide a first received audio signal based on the modulation component of the first wireless signal,
receive a second input audio signal from the second music audio device, and
provide a combined audio signal based on the first received audio signal and the second input audio signal;
whereby the combined audio signal contains information based on both the first input audio signal and the second input audio signal.

13. The wireless network of claim 12 wherein the second wireless link module further comprises an FM transmitter adapted to:
receive the combined audio signal,
generate a frequency-modulated radio frequency signal having a frequency modulation component based on the combined audio signal, and
provide an FM radio signal based on the frequency-modulated radio frequency signal and having a carrier frequency and a modulation format compatible with FM band radio receivers;
whereby the FM radio signal contains information based on both the first input audio signal and the second input audio signal.

14. The wireless network of claim 12 wherein the second wireless link module further comprises:
a link transmitter adapted to
receive the combined audio signal,
generate a modulated radio frequency signal having a modulation component based on the combined audio signal, and
provide a second wireless signal based on the modulated radio frequency signal;
whereby the second wireless signal contains information based on both the first input audio signal and the second input audio signal.

15. The wireless network of claim 14 wherein the second wireless link module further comprises an FM transmitter adapted to:
receive the combined audio signal,
generate a frequency-modulated radio frequency signal having a frequency modulation component based on the combined audio signal, and
provide an FM radio signal based on the frequency-modulated radio frequency signal and having a carrier frequency and a modulation format compatible with FM band radio receivers;
whereby the FM radio signal contains information based on both the first input audio signal and the second input audio signal.

16. A method comprising:
generating a first input audio signal at a first music audio device;
receiving the first input audio signal at a first wireless link module;
transmitting from the first wireless link module a first wireless signal having a modulation component based on the first input audio signal;
receiving the first wireless signal at a second wireless link module;
providing at the second wireless link module a first received audio signal based on demodulating the first wireless signal;
generating a second input audio signal at a second music audio device;
receiving the second input audio signal at the second wireless link module; and
providing at the second wireless link module a combined audio signal based on the first received audio signal and the second input audio signal;
whereby the combined audio signal contains information based on both the first input audio signal and the second input audio signal.

17. The method of claim 16 further comprising:
transmitting from the second wireless link module a second wireless signal having a modulation component based on the combined audio signal;
whereby the second wireless signal contains information based on both the first input audio signal and the second input audio signal.

18. The method of claim 17 wherein the first wireless signal has a carrier frequency approximately equal to a first channel frequency and the second wireless signal has a carrier frequency approximately equal to a second channel frequency.

19. The method of claim 18 further comprising:
receiving the second wireless signal at an FM radio receiver; and
demodulating the FM radio signal and providing a received combined audio signal substantially similar to the combined audio signal;
wherein the transmitting from the second wireless link module is further adapted such that the second wireless signal has a frequency modulation component based on the combined audio signal and has a carrier frequency and a modulation format compatible with FM broadcast band radio receivers.

20. The method of claim 16 further comprising:
providing at the first wireless link module a user control interface and receiving a control value from the user control interface;
transmitting from the first wireless link module a wireless control signal having a modulation component based on the control value;
receiving the wireless control signal at the second wireless link module; and
providing at the second wireless link module a received control value based on demodulating the wireless control signal;
whereby the received control value contains information based on the control value.

21. The method of claim 20 further comprising:
modifying an operating parameter of the second wireless link module based on the received control value.

22. The method of claim 20 further comprising:
receiving the received control value at a music audio device coupled to the second wireless link module; and
modifying an operating parameter of the music audio device based on the received control value.

23. The method of claim 20 further comprising:
receiving the received control value at an audio system coupled to the second wireless link module; and
modifying an operating parameter of the audio system based on the received control value.
